(19) United States
(12) Patent Application Publication
(10) Pub. No.: US 2011/0225606 A1
(43) Pub. Date: Sep. 15, 2011

(54) Television Content Metadata

(75) Inventors: Chad Michael Williams, San Mateo, CA (US); Matt Henry Van der Staay, San Jose, CA (US); Imran Arif Maskatia, Hayward, CA (US); Arleen Camaganacan Fernando, Redwood City, CA (US); Paul R. Cooper, San Jose, CA (US)

(73) Assignee: MICROSOFT CORPORATION, Redmond, WA (US)

(21) Appl. No.: 12/720,218

(22) Filed: Mar. 9, 2010

(51) Int. Cl. H04N 7/16; H04N 7/173

(52) U.S. Cl. 725/28; 725/109

(57) ABSTRACT

Television content metadata techniques are described. In one or more implementations, metadata received in a stream of television content at the client device from a content provider via a network is normalized. The stream of television content having the normalized metadata is exposed for consumption by one or more applications that are executable on the client device.

### BACKGROUND

Users have access to television content from a wide variety of sources. For example, users initially had access to television content that was broadcast “over the air” from local television stations. Since then, the availability of television content continues to increase such that a typical user may have access to television content from a wide variety of different sources, some of which may even be spread across the world. However, each of these sources may follow different conventions in providing the content, which may become problematic to traditional client devices that were configured to consume a particular kind of content.

For example, functionality that was available to the client device to consume content for which the client device was configured may not be available when consuming content that follows a different convention. Therefore, a user's experience with television content that follows these different conventions may be diminished and lead to user frustration with both the television content and the client device itself.

### SUMMARY

Television content metadata techniques are described. In one or more implementations, metadata is normalized that is received in a stream of television content at the client device from a content provider via a network. The stream of television content having the normalized metadata is exposed for consumption by one or more applications that are executable on the client device.

In one or more implementations, a client device includes one or more modules implemented at least in part by hardware and configured to receive a stream of television content from a distribution system via a network, translate metadata received in the stream of television content using information obtained via the network, and stream the stream of television content having the translated metadata to one or more applications that are executable on the client device.

In one or more implementations, one or more computer-readable media include instructions that are stored thereon that, responsive to execution by a client device, cause the client device to perform operations comprising retrieving information from a metadata provider via a network and translating ratings metadata received in a stream of television content received via the network using the information retrieved from the metadata provider. The stream of television content is not received from the metadata provider. The stream of content including the translated ratings metadata is exposed to one or more applications that are executable on the client device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques involving television content metadata.

FIG. 2 is an illustration of an example system showing a distribution system and a client device of FIG. 1 in greater detail as translating metadata including ratings metadata that was streamed with television content.

FIG. 3 is an illustration of an example system showing a distribution system and a client device of FIG. 1 in greater detail as retrieving information from a metadata provider to translate metadata that was streamed with television content

FIG. 4 is a flow diagram depicting a procedure in an example implementation in which metadata streamed with television content is normalized for consumption by one or more applications of a client device.

FIG. 5 is a flow diagram depicting a procedure in an example implementation in which ratings metadata streamed with television content is translated for consumption by one or more applications of a client device.

### DETAILED DESCRIPTION

### Overview

Users have access to an ever increasing range of television content. However, this television content may follow a variety of different conventions, which may be troublesome to functionality of the client device that was not configured to address these different conventions. One example of this involves metadata that is streamed with the television content, such as ratings information. Ratings information may follow a variety of different conventions. Consequently, effectiveness of parental control functionality of the client device that does not address these different conventions may be diminished and even fail, thereby reducing the overall usefulness of the client device.

Techniques involving television content metadata are described. In various implementations, metadata streamed with television content is normalized for use by other applications of a client device that received the television content. For example, the client device may receive a stream of television content and detect that metadata in the stream is not compatible with applications that are also executed on the client device, such as to provide parental controls, electronic program guide (EPG) applications, and so on. Accordingly, the client device may retrieve information over a network (e.g., the Internet) that may be used to translate the metadata into a form that is understood by the applications. Thus, functionality of the applications may be preserved without modification to the applications, further discussion of which may be found in relation to the following sections.

In the following discussion, an example environment is first described that is operable to perform television content metadata techniques. Example procedures are then described that may be employed in the example environment, as well as in other environments. Although these techniques are described as employed within a television environment in the following discussion, it should be readily apparent that these techniques may be incorporated within a variety of environments without departing from the spirit and scope thereof.

### Example Environment

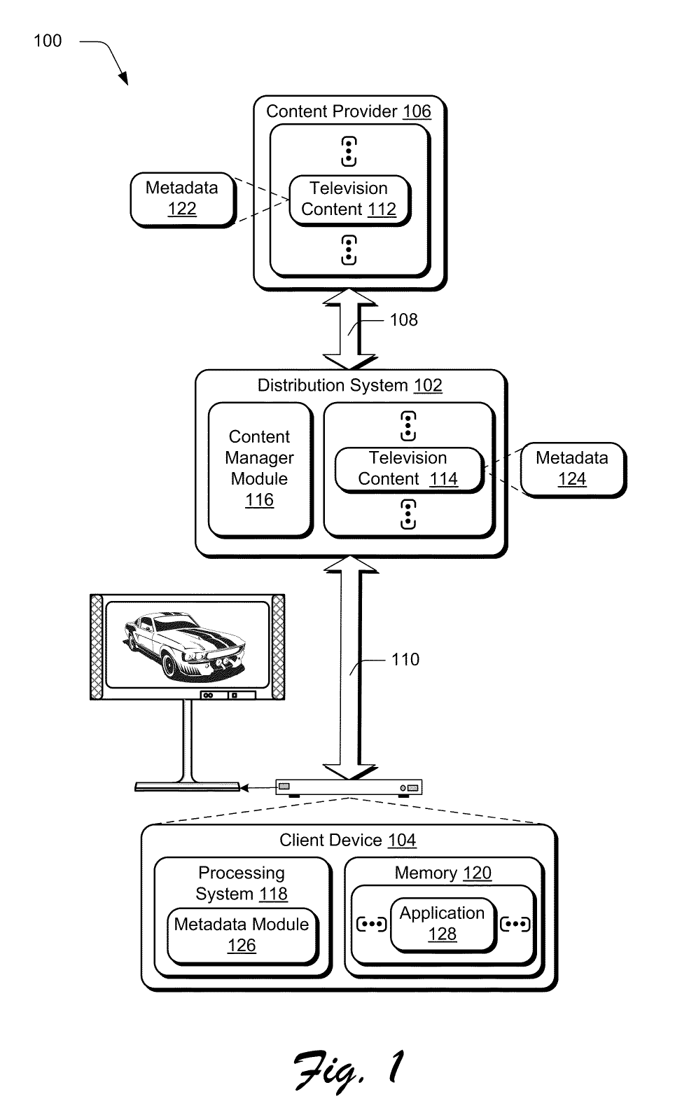

FIG. 1 is an illustration of an environment 100 in an example implementation that is operable to perform television content metadata techniques. The illustrated environment 100 includes a distribution system 102 of a network operator which may employ one or more distribution servers, a client device 104 and a content provider 106 that are communicatively coupled, one to another, via network connections 108, 110. In the following discussion, the distribution system 102, the client device 104 and the content provider 106 may be representative of one or more entities, and therefore reference may be made to a single entity (e.g., the client device 104) or multiple entities (e.g., the computing devices 104, the content providers 106, and so on). Additionally, although a plurality of network connections 108, 110 are shown separately, the network connections 108, 110 may be representative of network connections achieved using a single network or multiple networks. For example, network connections 108, 110 may be representative of a broadcast network with back channel communication, an Internet Protocol (IP) based network, and so on without departing from the spirit and scope thereof.

The client device 104 may be configured in a variety of ways. For example, the client device 104 may be configured as a general purpose computer as illustrated that is capable of communicating over the network connection 110, such as a desktop computer (e.g., a media center computer), a laptop computer, a netbook, a tablet personal computer, and so on. The client device 104 may also be configured to specific implementations, such as a mobile station, an entertainment appliance, a set-top box communicatively coupled to a display device as illustrated, a wireless phone, a game console, and so forth.

The content provider 106 includes one or more items of television content 112. The television content 112 may include a variety of data, such as television programming, video-on-demand (VOD) files, “premium” television content (e.g., pay-per-view, subscription based television content), and so on. The television content 112 is communicated over the network connection 108 to the distribution system 102.

Television content 112 communicated via the network connection 108 is received by the distribution system 102 and may be stored as one or more items of television content 114. The television content 114 may be the same as or different from the television content 112 received from the content provider 106. For example, the distribution system 102 is illustrated as including a content manager module 116. The content manager module 116 is representative of functionality to configure content 114 for streaming over the network connection 110 to the client device 104.

The content manager module 116, for instance, may configure content 112 received from the content provider 106 to be suitable for transmission over the network connection 108, such as to “packetize” the content 114 (e.g., using headers) into a plurality of streams that are encapsulated within a transport stream for distribution over the Internet, map the content 114 to particular channels, and so on. In another instance, the content manager module 116 may configure the television content 114 to include additional data for broadcast to the client device 104, such as electronic program guide data, and so on. A variety of other instances are also contemplated involving metadata as will be further described later in the discussion.

The client device 104 typically includes hardware and software for output of the television content 114, e.g., by the illustrated display device and speakers. As such, the client device 104 may be configured in a variety of ways to receive the television content 114 streamed over the network connection 110 as previously stated.

The client device 104, as illustrated in the environment 100 of FIG. 1, also includes a processing system 118 and memory 120. The processing system 118 may include one or more processors that are configured to execute instructions that are stored in the memory 120. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth.

Additionally, although a single memory 120 is shown for the client device 104, a wide variety of types and combinations of memory may be employed. For example, the memory 120 may be representative of random access memory (RAM), hard disk memory, compact discs (CD), digital video disc (DVD), flash storage devices, removable medium memory (e.g., a thumb drive), and other types of computer-readable media to store instructions.

Thus, in the environment 100 of FIG. 1, the content provider 106 may broadcast the content 114 over a network connection 108 to a multiplicity of network operators, an example of which is illustrated as distribution system 102. The distribution system 102 may then stream the content 114 over a network connection 110 to a multitude of computing devices, an example of which is illustrated as client device 104. The client device 104 may then store the content 114 and/or render the content 114 immediately for output as it is received, such as when the client device 104 is configured to include digital video recorder (DVR) functionality.

As previously described, the client device 104 may obtain television content 114 from a wide variety of different sources. For example, the distribution system 102 may be configured to obtain television content 112 from a plurality of different content providers 106. Additionally, the client device 104 itself may be configured to obtain television content from a variety of different distribution systems 102. Accordingly, the television content 114 obtained from the variety of sources may follow a variety of different conventions.

For example, the television content 112 obtained from the content provider 106 may be streamed with metadata 122. The metadata 122 may describe a variety of different characteristics of the corresponding television content 112, such as title, actors, director, production company, author, copyright date, location information, ratings, and so on. Likewise, the distribution system 102 may add metadata 124 to the television content 114 which may be different than the metadata 112 obtained with the television content 112 from the content provider 106. Thus, the television content 114 received by the client device 104 may include a wide variety of metadata that may follow a variety of different conventions.

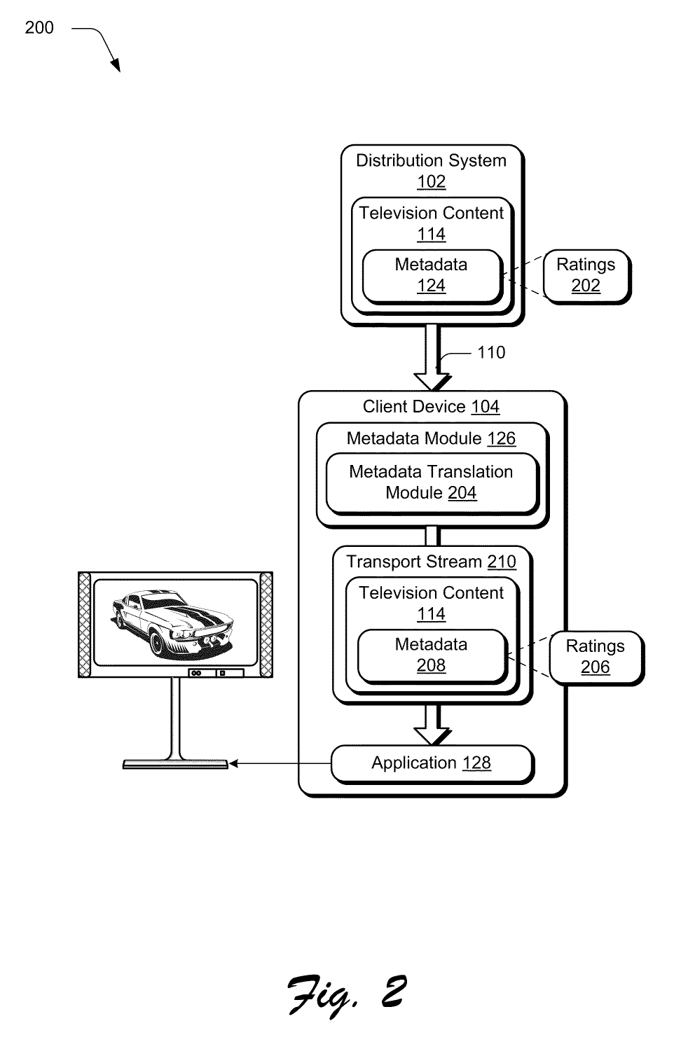

The client device 104 is illustrated as including a metadata module 126 that is representative of functionality that address metadata associated with television content. For example, the metadata module 126 may be configured to normalize metadata 124 received with television content 114. Therefore, this normalized metadata may be streamed with the television content 114 to one or more applications 128 that are configured to consume the television content 114. The applications 128 may be configured to consume the television content and metadata in a variety of ways as well as provide a wide variety of functionality, include an operating system of the client device 104. In this way, the applications 128 of the client device 104 may consume the television content without modification, further discussion of which may be found in relation to FIG. 2.

It should be noted that one or more of the entities shown in FIG. 1 may be further divided (e.g., the distribution system 102 may be implemented by a plurality of servers in a distributed computing system), combined, and so on and thus the environment 100 of FIG. 1 is illustrative of one of a plurality of different environments that may employ the described techniques. For example, functionality of the metadata module 124 of the client device 104 may be implemented (e.g., in part or in whole) by the distribution system 102. A variety of other examples are also contemplated.

FIG. 2 is an illustration of an example system 200 showing the distribution system 102 and the client device 104 of FIG. 1 in greater detail as translating metadata including ratings metadata that was streamed with television content. In the illustrated system 200, the distribution system 102 streams television content 114 and metadata 124 to the client device 104 over a network connection 110. In this instance, the metadata 124 includes ratings 202 metadata defined within a particular ratings system. However, one or more applications 128 of the client device 104 may not be configured to address the ratings 202.

For example, the application 128 may be configured to consume metadata configured in accordance with a United States Television Ratings System that includes the following ratings: TV-Y, TV-Y7, TVY7-FV, TV-G, TV-PG, TV-14 and TV-MA. The ratings 202 in the television content 114, however, may be configured in accordance with a Malaysian ratings system that includes the following ratings: U, PG-13, 18-SG, 18-SX, 18-PA and 18-PL. Accordingly, the metadata module 126 may employ a metadata translation module 204 to translate the ratings 202 in the television content 114 configured in accordance with the Malaysian ratings system to ratings 206 that are consistent with the U.S. ratings system.

The ratings 206 may then be included in metadata 208 streamed with the television content 114 in a transport stream 210 to the application 128. For example, the transport stream 210 may be configured (e.g., packetized) in accordance with one or more transport protocols, e.g., MPEG2. Thus, functionality of the application 128 may leverage the ratings 206 included in the metadata 208 without making a change to the application 128, itself. For instance, native parental control functionality of the application 128 may be utilized and accommodate a variety of different conventions using metadata 208 that has been normalized by the metadata module 126. In this way, the application 128 is not made “aware” that the translation has occurred, e.g., that the original ratings were consistent with a Malaysian convention. As before, the application 128 may be configured in a variety of different ways, such as a media consumption application, an operating system, an application to support digital video recorder functionality, an application to configure an electronic program guide (EPG), and so on. Thus, the metadata module 126 may enable this variety of applications 128 to consume a variety of different metadata without modification to the application 128.

The metadata 124 may be translated by the metadata module 126 (and more particularly functionality represented by the metadata translation module 204) in a variety of ways. For example, the metadata module 126 may perform one or more “look ups” using one or more tables that are local to the client device 104 to translate the metadata 124 from one convention to another. In another example, however, information to translate the metadata 124 may not be available locally on the client device 104. Accordingly, the client device 104 may be configured to retrieve this information to perform the translation, further discussion of which may be found in relation to the following figure.

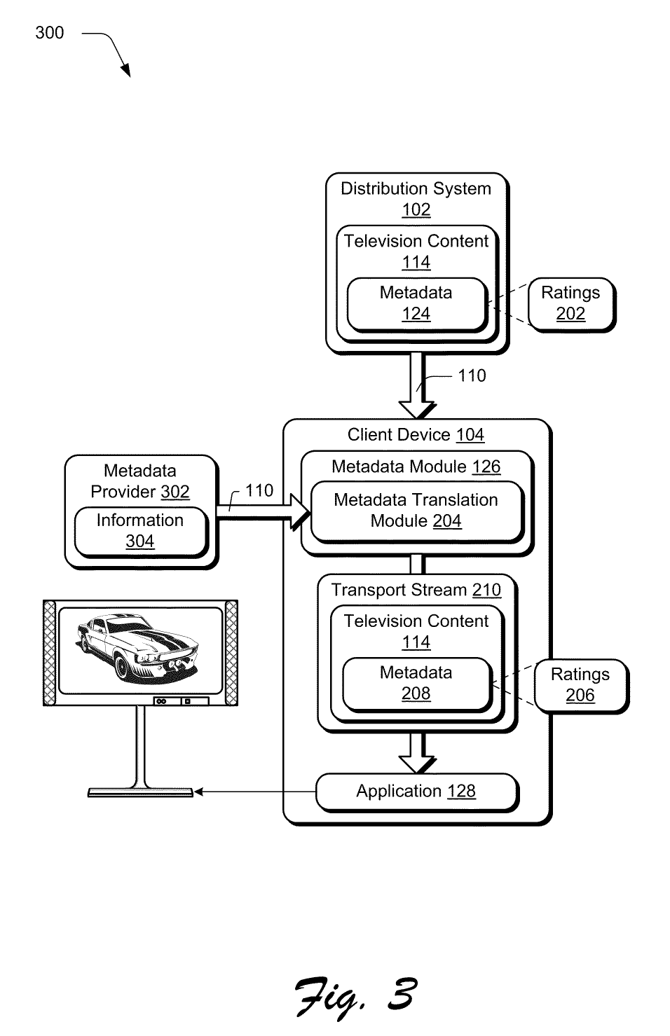

FIG. 3 is an illustration of an example system 300 showing the distribution system 102 and the client device 104 of FIG. 1 in greater detail as retrieving information from a metadata provider to translate metadata that was streamed with television content. Continuing with the previous example, the client device 104 may receive television content 114 from the distribution system 102 that includes metadata 124 (e.g., ratings 202) that is not compatible with the application 128. However, unlike the example discussed in relation to FIG. 3, the metadata module 126 is not currently configured to translate the ratings 202 into a form that is compatible with the application 128.

Accordingly, in this example system 300 the metadata module 126 causes the client device 104 to interact with a metadata provider 302 to retrieve information 304 that is usable to perform the translation. For example, the information 304 may be usable in conjunction with an XML transform to translate the ratings 202 into the ratings 206 and other metadata 208 that is compatible with the application 128. The information 304 may be obtained in a variety of ways, such as periodically, in real time in response to detection of the metadata 124 that is incompatible with the application 128, and so on. Further discussion of retrieval of information 304 to translate metadata 124 may be found in relation to the following procedures.

Generally, any of the functions described herein can be implemented using software, firmware, hardware (e.g., fixed-logic circuitry), manual processing, or a combination of these implementations. The terms “module”, “functionality”, “engine” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer-readable memory devices, e.g., the memory 120 of the client device 104. The features of the television content metadata techniques are platform-independent, meaning that the techniques may be implemented on a variety of commercial computing platforms having a variety of processors.

### Example Procedures

The following discussion describes television content metadata techniques that may be implemented utilizing the previously described environment, systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1, the systems 200, 300 of FIGS. 2 and 3, respectively.

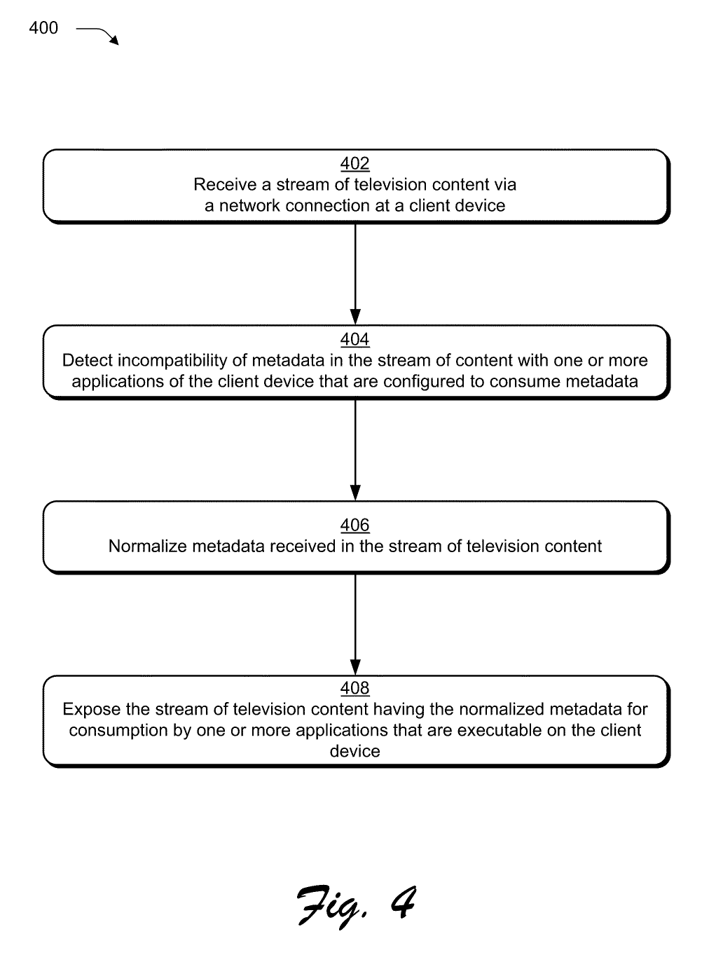

FIG. 4 depicts a procedure 400 in an example implementation in which metadata streamed with television content is normalized for consumption by one or more applications of a client device. A stream of television content is received via a network connection at a client device (block 402). For example, the client device 104 may receive television content via a stream from a distribution system 102 over an Internet-protocol based network connection 110, via a broadcast, and so on.

An incompatibility is detected of metadata in the stream of content with one or more applications of the client device that are configured to consume metadata (block 404). The metadata module 126, for instance, may be configured to provide a transport stream 210 of television content 114 having certain characteristics, such as in compliance with one or more U.S. broadcast standards and conventions for metadata 124 that is streamed with the television content 114. However, the metadata 124 may not be compatible with the conventions supported by the application 128, such as by following a naming convention such that metadata 124 that is relevant to functionality of the application 128 cannot be located by the application 128. For instance, the metadata 124 may follow a different naming convention for fields in the metadata, may be missing metadata (e.g., ratings 202 metadata), and so on.

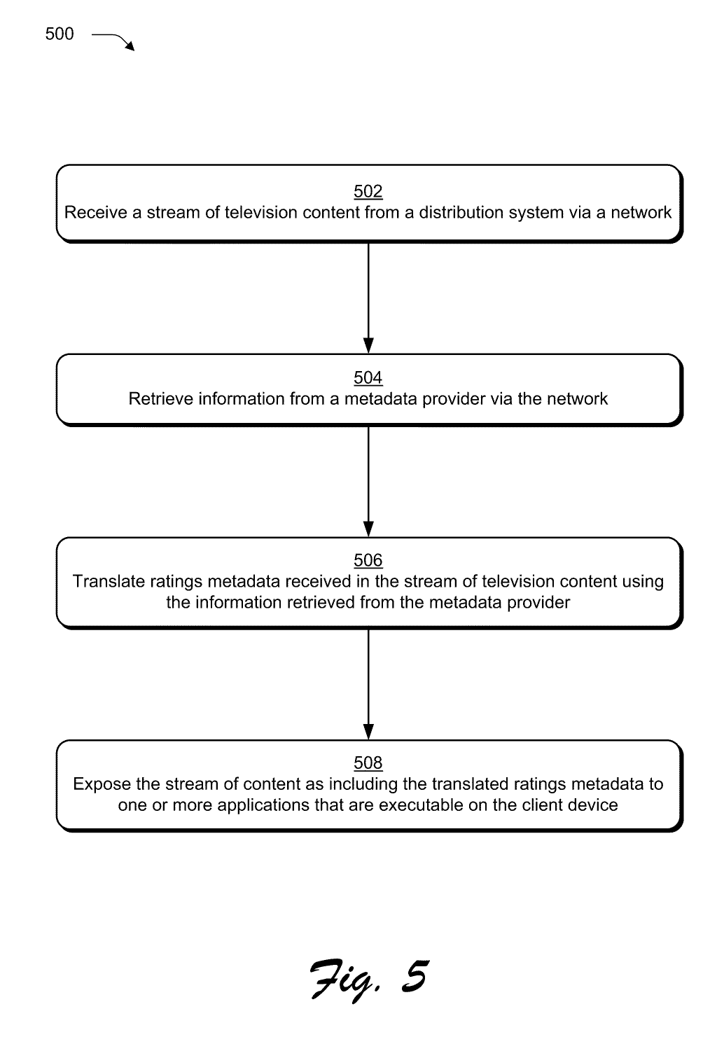

Metadata is normalized that is received in the stream of television content (block 406). For example, the metadata module 126 may employ the metadata translation module 204 to translate metadata 124 from being compatible with one contention to another convention, such as by renaming fields, reordering an arrangement of the metadata 124, converting the values in the metadata 124, and so on. A variety of other examples of normalization of metadata are also contemplated, such as by adding data, further discussion of which may be found in relation to FIG. 5.

The stream of television content having the normalized metadata is exposed for consumption by one or more applications that are executable on the client device (block 408). The metadata module 126, for instance, may expose a transport stream 210 of the television content 114 and the metadata 208 for consumption by applications 128 of the client device 104, such as an operating system of the client device 104, applications having parental control functionality, electronic program guides, and so on. Thus, as previously stated the application 128 may consume the normalized metadata 208 without changing the application 128.

FIG. 5 depicts a procedure 500 in an example implementation in which ratings metadata streamed with television content is translated for consumption by one or more applications of a client device. A stream of television content is received from a distribution system via a network (block 502). As before, the stream of television content 114 may be received in a variety of ways, such as via the Internet, via a broadcast (e.g., “over the air,” satellite, from a cable provider), and so on.

Information is retrieved from a metadata provider via the network (block 504). For example, the metadata module 126 may leverage functionality of the client device 104 to obtain information 304 that may be used to translate the metadata 124 from over the network connection 110. The metadata module 126 may perform this action in response to a variety of different circumstances, such as responsive to detection that the metadata is not compatible with the application 128 (e.g., as previously described in relation to block 404), detection of incompatibility with the metadata module 126 itself, and so on.

The information may be obtained in a variety of ways. For instance, the metadata module 126 may contact the distribution system 102 to obtain the information 304 (e.g., the distribution system 102 includes the functionality of the metadata provider 302). In another instance, the metadata module 204 may leverage functionality (e.g., browser functionality) of the client device 104 to perform an internet search to locate a network address of the metadata provider 302. A variety of other instances are also contemplated, such as to use a list of network addresses of metadata providers 302 that are likely to include the information 304.

Ratings metadata received in the stream of television content is translated using the information retrieved from the metadata provider (block 506). For instance, the metadata module 126 may use the information 304 to perform an XML transform to translate the ratings 202, such as into an age based ratings system.

In another instance, the translation may be performed to provide part of the metadata information that is “missing” and therefore “fill in the gaps” of the metadata. For example, the application 128 may include functionality that is dependent on particular parts of the metadata information, e.g., ratings metadata. Accordingly, the information 304 obtained by the metadata module 126 from the metadata provider 302 may include the ratings for the television content 114. The metadata module 126 may then include this information 304 as part of the metadata 208 that is streamed to the application 128 in the transport stream 210. A variety of other instances are also contemplated, such as through use of a table lookup to translate a Malaysian rating to a U.S. rating as previously described.

The stream of content is exposed as including the translated ratings metadata to one or more applications that are executable on the client device (block 508). For example, the stream of television content 114 may be exposed to be consistent with a standard television broadcast such that the application 128 is unaware that the television content 114 and metadata 124 were obtained via an Internet-protocol based network, thereby allowing the metadata module 126 to leverage legacy applications. A variety of other examples are also contemplated, such as to configure the transport stream 210 such that the application 128 is aware of the source of the television content 114 but unaware of the translation of the metadata 124 into metadata 208.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by a client device, the method comprising:
normalizing metadata received in a stream of television content at the client device from a content provider via a network; and
exposing the stream of television content having the normalized metadata for consumption by one or more applications that are executable on the client device.

2. A method as described in claim 1, wherein the network is an Internet Protocol based network.

3. A method as described in claim 1, wherein the exposed stream of content is configured in accordance with one or more MPEG2 transport stream protocols.

4. A method as described in claim 1, wherein the normalizing includes translating the metadata received in the stream of television content.

5. A method as described in claim 4, wherein the translating is performed using information retrieved via a network connection.

6. A method as described in claim 1, wherein the metadata received in the stream of television content includes ratings information and the normalizing includes translating the metadata received in the stream of television content into an age-based ratings system.

7. A method as described in claim 6, wherein the translating is performed using an XML transform.

8. A method as described in claim 1, wherein the metadata is configured for consumption by parental control functionality of the one or more applications.

9. A method as described in claim 1, wherein at least one said application is an operating system of the client device.

10. A method as described in claim 1, wherein the normalizing is performed in real time as the metadata is received at the client device.

11. A client device comprising one or more modules implemented at least in part by hardware and configured to:
receiving a stream of television content from a distribution system via a network;
translating metadata received in the stream of television content using information obtained via the network; and
streaming the stream of television content having the translated metadata to one or more applications that are executable on the client device.

12. A client device as described in claim 11, wherein the network is an Internet Protocol based network.

13. A client device as described in claim 11, wherein the exposed stream of content is configured in accordance with one or more MPEG2 transport stream protocols.

14. A client device as described in claim 11, wherein at least one of the applications is an operating system of the client device.

15. A client device as described in claim 11, wherein the translated metadata is configured in accordance with an age-based ratings system.

16. A client device as described in claim 11, wherein the translating is performed using the retrieved information that is usable by the one or more modules as part of an XML transform.

17. One or more computer-readable media comprising instructions that are stored thereon that, responsive to execution by a client device, cause the client device to perform operations comprising:
retrieving information from a metadata provider via a network;
translating ratings metadata received in a stream of television content received via the network using the information retrieved from the metadata provider in which the stream of television content was not received from the metadata provider; and
exposing the stream of content as including the translated ratings metadata to one or more applications that are executable on the client device.

18. One or more computer-readable media as described in claim 17, wherein at least one of the applications is configured to output an electronic program guide.

19. One or more computer-readable media as described in claim 17, wherein at least one of the applications include parental control functionality.

20. One or more computer-readable media as described in claim 17, wherein at least one of the applications is configured as an operating system of the client device.
